(19) United States
(12) Patent Application Publication
(10) Pub. No.: US 2025/0020820 A1
(43) Pub. Date: Jan. 16, 2025

(54) RADIATION DETECTION APPARATUS HAVING A STABILIZED PHOTOMULTIPLIER

(71) Applicant: Luxium Solutions, LLC, Hiram, OH (US)

(72) Inventors: Diane L. FRUEHAUF, Hudson, OH (US); Douglas A. HILL, New Castle, PA (US); Artan DURAJ, Seven Hills, OH (US)

(21) Appl. No.: 18/771,605

(22) Filed: Jul. 12, 2024

Related U.S. Application Data
(60) Provisional application No. 63/513,779, filed on Jul. 14, 2023.

(51) Int. Cl. G01T 1/24; G01T 1/20; G01T 1/202; G01T 1/208

(52) U.S. Cl. CPC G01T 1/248; G01T 1/20181; G01T 1/202; G01T 1/208

(57) ABSTRACT

Apparatuses and methods as described herein can be used to help stabilize the gain of a semiconductor-based photomultiplier. In an embodiment, an apparatus can include a semiconductor-based photomultiplier. The apparatus can be configured to maintain a constant voltage output of between +/−0.002% and +/−15% of a breakdown voltage. A method for stabilizing a radiation detection device can include determining a breakdown voltage of a light source. The light source can be optically coupled to a silicon photomultiplier. The method can also include measuring a plurality of light outputs of the light source provided over a temperature range of 70 degrees and generating an individualized look-up table for the light source based on the measured plurality of light outputs over the said temperature range.

### CROSS-REFERENCE TO RELATED APPLICATION(S)

This application claims priority under 35 U.S.C. § 119 (c) to U.S. Provisional Application No. 63/513,779, entitled “RADIATION DETECTION APPARATUS HAVING A STABILIZED PHOTOMULTIPLIER,” by Diane L. FRUEHAUF et al., filed Jul. 14, 2023, which is assigned to the current assignee hereof and incorporated herein by reference in its entirety.

### FIELD OF DISCLOSURE

The present disclosure is directed to radiation detection apparatuses having silicon photomultipliers (SiPMs) within the housings.

### BACKGROUND

A radiation detection apparatus, which can be used to detect radiations such as X-ray, gamma-ray, alpha, beta radiations, can include a sealed housing having components therein. The radiation detection apparatus can include a scintillator and a SiPM, where the scintillator reacts to detecting a type of radiation by outputting photons which can be directed to and detected by the SiPM.

A SiPM is a semiconductor-based device (typically silicon) that can deliver an electronic signal with a total charge proportional to the number of absorbed photons. It consists of a large number of avalanche photodiodes (APDs) which are operated in Geiger mode. These Geiger-mode avalanche photodiodes (G-APDs), which may also be referred to as single photon avalanche photodiodes, are connected in parallel via individual quenching resistors. APDs convert incoming photons to an electrical signal and amplify it through avalanche multiplication. APDs require a voltage applied across their terminals to operate. When this applied reverse voltage (or “bias voltage”) is larger than the breakdown voltage, the APD is operating in what is called Geiger-mode. A SiPM operating in Geiger-mode can measure light intensity by counting photons. The number of photons a SiPM can count per unit time depends on the number of G-APDs included in the SiPM, and how quickly the individual G-APDs can recharge after being discharged upon detecting a photon.

However, the gain of an SiPM decreases with increases in temperature and negatively impacts the accuracy and performance of the SiPM. In use, the SiPM may need its gain adjusted, particularly when the temperature of the SiPM changes. Therefore, further improvements in apparatuses using SiPMs are desired.

### BRIEF DESCRIPTION OF THE DRAWINGS

The present disclosure may be better understood, and its numerous features and advantages made apparent to those skilled in the art by referencing the accompanying drawings. Embodiments are illustrated by way of example and are not limited in the accompanying figures.

FIG. 1 includes a depiction of an apparatus in accordance with an embodiment.

FIG. 2 includes a depiction of a control module that can be used in the apparatus of FIG. 1.

FIG. 3 includes a method to optimize the gain of the apparatus of FIG. 1.

FIG. 4 includes an illustration of a cross-sectional view of a radiation detection apparatus including a SiPM in accordance with an embodiment.

FIG. 5 includes an illustration of a perspective view of portions of a wiring board, SiPM, and an interface printed circuit board of the apparatus of FIG. 1, according to one embodiment.

Skilled artisans appreciate that elements in the figures are illustrated for simplicity and clarity and have not necessarily been drawn to scale. For example, the dimensions of some of the elements in the figures may be exaggerated relative to other elements to help improve understanding of embodiments of the invention.

### DETAILED DESCRIPTION

The following description, in combination with the figures, is provided to assist in understanding the teachings disclosed herein. The following discussion will focus on specific implementations and embodiments of the teachings. This focus is provided to assist in describing the teachings and should not be interpreted as a limitation on the scope or applicability of the teachings. In one embodiment, an apparatus can include a semiconductor-based photomultiplier. The apparatus can be configured to maintain a constant voltage output of between +/−1% and +/−15% of a breakdown voltage. A method for stabilizing a radiation detection device can include determining a breakdown voltage of a light source. The light source can be optically coupled to a silicon photomultiplier. The method can also include measuring a plurality of light outputs of the light source provided over a temperature range of 70 degrees and generating an individualized look-up table for the light source based on the measured plurality of light outputs over the said temperature range. Utilizing the method above advantageously provides a means to maintaining a gain stabilization within 1 degree of the breakdown voltage at any given temperature. However, other embodiments can be used based on the teachings as disclosed in this application.

The foregoing has outlined rather broadly and in a non-limiting fashion the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the scope of the invention as set forth in the appended claims.

As used herein, the term “compound semiconductor” is intended to mean a semiconductor material that includes at least two different elements. Examples include SiC, SiGe, GaN, InP, AlₓGa₍₁₋ₓ₎N where 0≤x<1, CdTe, and the like. A III-V semiconductor material is intended to mean a semiconductor material that includes at least one trivalent metal element and at least one Group 15 element. A III-N semiconductor material is intended to mean a semiconductor material that includes at least one trivalent metal element and nitrogen. A Group 13-Group 15 semiconductor material is intended to mean a semiconductor material that includes at least one Group 13 element and at least one Group 15 element. A II-VI semiconductor material is intended to mean a semiconductor material that includes at least one divalent metal element and at least one Group 16 element.

The term “avalanche photodiode” refers to a single photodiode having a light-receiving area of least 1 mm² and is operated in a proportional mode.

The term “SiPM” is intended to mean a photomultiplier that includes a plurality of photodiodes, wherein each of the photodiodes has a cell size less than 1 mm², and the photodiodes are operated in Geiger mode. The semiconductor material for the diodes in the SiPM can include silicon, a compound semiconductor, or another semiconductor material.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

The use of the word “about,” “approximately,” or “substantially” is intended to mean that a value of a parameter is close to a stated value or position. However, minor differences may prevent the values or positions from being exactly as stated. Thus, differences of up to ten percent (10%) (and up to twenty percent (20%) for semiconductor doping concentrations) for the value are reasonable differences from the ideal goal of exactly as described.

Group numbers corresponding to columns within the Periodic Table of Elements based on the IUPAC Periodic Table of Elements, version dated Nov. 28, 2016.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation, radiation detection and ranging arts.

Apparatuses and methods as described herein can be used to help stabilize the gain of a semiconductor-based photomultiplier. As the gain is stabilized, electronic pulses from the semiconductor-based photomultiplier or corresponding digital signals are individualized to adjust for the specific scintillation crystal as temperature changes during operation of the apparatus. Further, the method used to stabilize the gain can be performed as a background function (not visible to the user) while the apparatus is being used for one or more of its principal functions, such as radiation detection, imaging, ranging, or the like.

The technique incorporates very fast organic and heavy inorganic scintillator detectors to access lifetimes of nuclear exited states or radioactive isotope, respectively, in the few picoseconds region by utilizing the centroid, i.e., the first moment of a delayed time distribution D (t) without any background contributions.

The centroid shift directly obtains the mean lifetime from the centroids in fast-timing experiments to determine drifts in electronics as a function of time, temperature, and differences in source position. In order to be linear with and symmetric to the prompt curve, the present disclosure utilizes individualized and apparatus specific calculations to adjust for drifts. Specifically, an individualized calculation determines peaks over a range of temperatures for each individual apparatus, which includes the scintillation crystal and electronics package, shortly after manufacturing is complete. As the apparatus is used, the calculations are then used as an active feedback to compensate for voltage bias and stabilize gain, eliminating drift. As such, each apparatus will have an individualized reference to compensate for crystal light output changes over a given range of temperatures to regulate gain stabilization thus ensuring linearity and symmetry to the centroids measured over a full energy peak ranging from 0 keV to 1400 keV.

In an embodiment, an apparatus can include a semiconductor-based photomultiplier. The apparatus can be configured to inject a first input pulse into the semiconductor-based photomultiplier; determine a revised bias voltage for the semiconductor-based photomultiplier based at least in part on a first output pulse corresponding to the first input pulse and a second output pulse from the semiconductor-based photomultiplier that is obtained at another time as compared to the first output pulse; and adjust a bias voltage for the semiconductor-based photomultiplier to the revised bias voltage. Adjusting the bias voltage can be performed such that a gain of the semiconductor-based photomultiplier is closer to a predetermined value, as compared to not adjusting the bias voltage.

Embodiments using gain stabilization concepts as described herein can be used in a variety of different apparatuses that use semiconductor-based photomultipliers. Such apparatuses can include radiation detection apparatuses, ranging apparatuses, and other suitable apparatuses. The former can include nuclear physics tools, medical imaging tools, well logging or well bore tools, or the like. Ranging tools can include Light Detection and Ranging (“LiDAR”) tools, three-dimensional (“3D”) imaging tools, or the like. The semiconductor-based photomultiplier is coupled to a light source that may be within the apparatus or outside of the apparatus. The light source can include a scintillator, a laser, a light emitting diode (“LED”) (inorganic or organic), or another suitable light source. In the description below, the apparatus will be described with respect to a radiation detection apparatus to provide an exemplary embodiment. After reading this specification, skilled artisans will appreciate that many other apparatuses may be used without departing from the concepts as described herein.

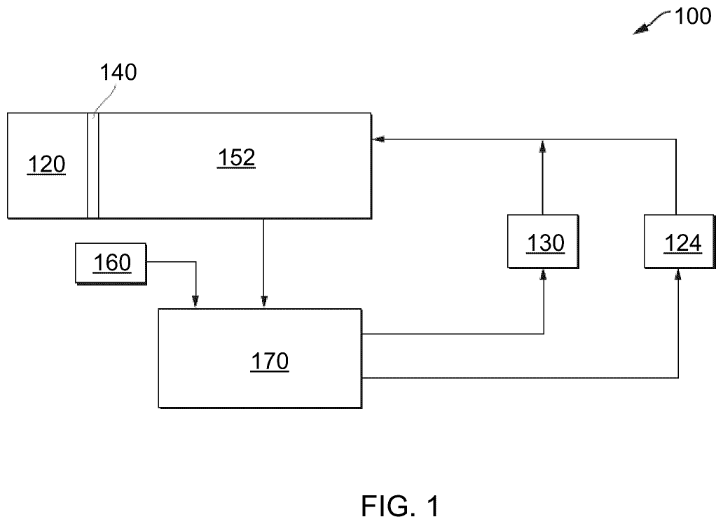

FIG. 1 illustrates an embodiment of a radiation detection apparatus 100. The radiation detection apparatus 100 can be a medical imaging apparatus, a well logging apparatus, a security inspection apparatus, for military applications, or the like. The radiation detection apparatus 100 can include a light source 120, a semiconductor-based photomultiplier 152, and an optical coupler 140 that optically couples to the light source 120 or another luminescent material to the semiconductor-based photomultiplier 152. The semiconductor-based photomultiplier 152 is electrically coupled to a control module 170, a pulse injector circuit 130, and a bias voltage supply circuit 124. The control module 170 is coupled to the pulse injector circuit 130 and the bias voltage supply circuit 124. The control module 170 may also be coupled to another component within the apparatus, another apparatus (not illustrated), such as a computer, persistent memory, a display, a keyboard, or the like.

An optional temperature sensor 160 may be located adjacent to an interface between the light source 120 and the semiconductor-based photomultiplier 152. In particular embodiment, the temperature sensor 160 can be on the light source, on the semiconductor-based photomultiplier 152, or within the semiconductor-based photomultiplier 152 (e.g., as a thermistor in an integrated circuit or on a circuit board). In another particular embodiment, the temperature sensor 160 may be at most 9 cm, at most 2 cm, or at most 0.9 cm from the light source 120, the semiconductor-based photomultiplier 152, or both. In another embodiment, the temperature sensor 160 may be within an integrated circuit within the control module 170. Additionally, the temperature sensor 160 may be used for other reasons, for example, to account for light output from the light source 120 as the temperature of the light source 120 changes.

In FIG. 1, arrows illustrate principal directions in which signals flow. In another embodiment, one or more of the electrical couplings may be bidirectional. The light source 120 can be a luminescent material, such as a scintillator, and include a halide, an oxide, or another suitable material that can emit ultraviolet or visible light in response to absorbing targeted radiation, such as gamma rays, neutrons, ionized radiation, or the like. The optical coupler 140 can include a window, a silicone or acrylic material, or another transparent material. If needed or desired, a wavelength shifter may be used to change the wavelength of the emitted light from the light source 120 to a different wavelength that allows for a higher quantum efficiency of the semiconductor-based photomultiplier 152. In another apparatus, such as a ranging or other apparatus, the light source can be a laser, an LED, or the like. In such an application, light may be emitted from a light source and reflected by an object outside the apparatus and received by the semiconductor-based photomultiplier 152. In another application, the light source may be external to the apparatus 100, and light from the light source can be received by the semiconductor-based photomultiplier 152. In such applications, the optical coupler 140 may not be used.

The apparatuses and methods are well suited when the semiconductor-based photomultiplier is a silicon photomultiplier (SiPM). Still, the apparatuses and methods described herein may be used with another semiconductor-based photomultiplier, such as an avalanche photodiode. A SiPM can have a gain that changes with a change in temperature. The apparatuses and processes as described in more detail below can be used to help stabilize the gain of a semiconductor-based photomultiplier, such as a SiPM.

The control module 170 can serve one or more different functions. When the apparatus is a radiation detection apparatus, the control module 170 can receive an electronic pulse from the semiconductor-based photomultiplier 152 and perform one or more functions. For example, the control module 170 may be configured to count radiation events, identify a radiation source, or the like. When used in a ranging application, the control module 170 can determine a distance between the semiconductor-based photomultiplier 152 and a radiation source 120, a light source, or an object that reflects light that is received by the semiconductor-based photomultiplier 152.

The control module 170 can also be configured to help stabilize the gain of the semiconductor-based photomultiplier 152. In a particular implementation, the control module 170 can be coupled to the pulse injector circuit 130, and the control module 170 can send control signals to the pulse injector circuit 130, which in turn can send a pulse to the semiconductor-based photomultiplier 152. The control module 170 can also be coupled to the bias voltage circuit 124, which in turn can set the bias voltage for the semiconductor-based photomultiplier 152. The bias voltage circuit 124 may supply a direct current voltage. A capacitor can be used to keep the voltage from the bias voltage circuit 124 from interfering with the operation of the pulse injector circuit 130. Such capacitor may be part of the pulse injector circuit 130 or may be located between the pulse injector circuit 130 and where the pulse injector circuit 130 connects to an input signal line to the semiconductor-based photomultiplier 152. The gain stabilization function is described in conjunction with a flow chart later in this specification.

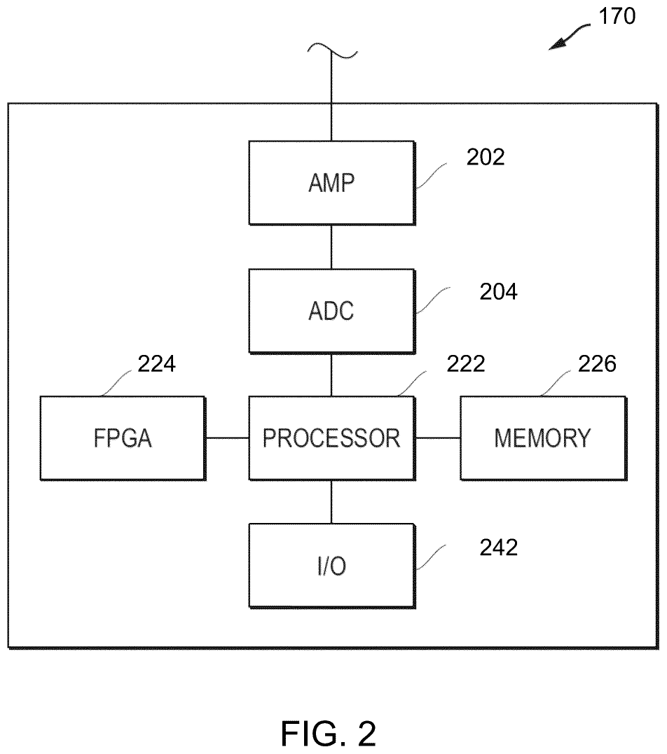

FIG. 2 includes an illustration of components within the control module 170. The semiconductor-based photomultiplier 152 is coupled to an amplifier 202 within the control module 170. In an embodiment, the amplifier 202 can be a high fidelity amplifier. The amplifier 202 can amplify the electronic pulse, and the amplified electronic pulse can be converted to a digital signal at an analog-to-digital converter (“ADC”) 204 that can be received by the processor 222. The processor 222 can be coupled to a programmable/re-programmable processing module (“PRPM”), such as a field programmable gate array (“FPGA”) 224 or application-specific integrated circuit (“ASIC”), a memory 226, and an input/output (“I/O”) module 242, the pulse injector circuit 130, and the bias voltage circuit 124. The couplings may be unidirectional or bidirectional. In another embodiment, more, fewer, or different components can be used in the control module 170. For example, functions provided by the FPGA 224 may be performed by the processor 222, and thus, the FPGA 224 is not required. The FPGA 224 can act on information faster than the processor 222.

During operation, an electronic pulse from the semiconductor-based photomultiplier 152 can be received at the control module 170. The processor 222 can analyze the signal to determine if the signal corresponds to the functions for which the apparatus is used by the user, such as radiation detection, ranging, or the like or for a gain stabilization function. For example, for radiation detection, the processor 222 can analyze the digital signal from the ADC 204 and determine if the digital signal corresponds to a radiation event that reaches a peak and then has an exponential decay, or if the digital signal corresponds to a pulse injected from the pulse injector circuit 130 to the semiconductor-based photomultiplier 152. The pulse injected from the pulse injector circuit 130 will not have an exponential decay, as would be seen with a radiation event.

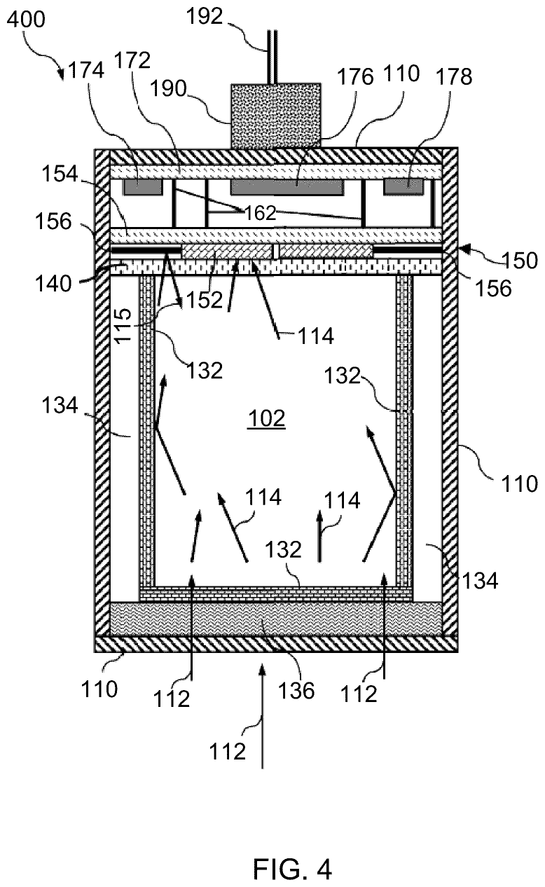

Some or all of the functions described with respect to the FPGA 224 may be performed by the processor 222, and therefore, the FPGA 224 is not required in all embodiments. Further, the FPGA 224, the memory 226, the I/O module 242, or any combination thereof may be within the same integrated circuit, such as the processor 222. In another embodiment, the control module 170 does not need to be housed within the apparatus 100. Still further, at least one component of the control module 170, as illustrated in FIG. 4, may be within the apparatus 100, and at least one other component may be outside the apparatus 100. The control module 170 within the apparatus 100 can allow operations to proceed quickly without having data transmission delays.

In one embodiment, before starting the method, the bias voltage can be set to a value to achieve a desired gain for a semiconductor-based photomultiplier 152. The processor 222 can send an instruction to the bias voltage circuit 124. The bias voltage control circuit 124 can supply a bias voltage to the semiconductor-based photomultiplier 152 to set the gain for the semiconductor-based photomultiplier 152. When the semiconductor-based photomultiplier 152 is a SiPM, the bias voltage may be within a few volts of an average breakdown voltage for the diodes in the SiPM. The bias voltage may be higher or lower than the average breakdown voltage. The breakdown voltage may depend on the semiconductor material of the diode, the dopant concentrations at n-p junctions, and the temperature of the semiconductor-based photomultiplier 152. In an embodiment, the bias voltage can be in a range of approximately 20 VDC to 30 VDC. The actual voltage used for the bias voltage may depend on where the apparatus 100 operates well, for example, to provide an acceptable signal-to-noise ratio. The bias voltage may be set initially at room temperature, such as in a range of 20° C. to 25° C. This initial setting of the bias voltage may be performed before the final installation of the apparatus 100. Thus, the initial setting may be performed at a test bench, at a factory, or before installation in the field is completed, or during a start-up sequence. In another embodiment, the bias voltage may be initially set as described with respect to the method below. During operation, the semiconductor-based photomultiplier 152 can be at least 1.1° C., at least 5° C., or at least 11° C. away from the temperature used when initially setting the bias voltage.

If needed or desired, additional testing may be performed to generate temperature and corresponding bias voltage information in order to keep the gain of the semiconductor-based photomultiplier 152 within a predetermined range, such as at most 15%, at most 9%, at most 5%, at most 3% or at most 1% or at least 0.002%, at least 0.02%, at least 0.2% of the gain as initially set or reset. Such information may be stored in the FPGA 224 or the memory 226.

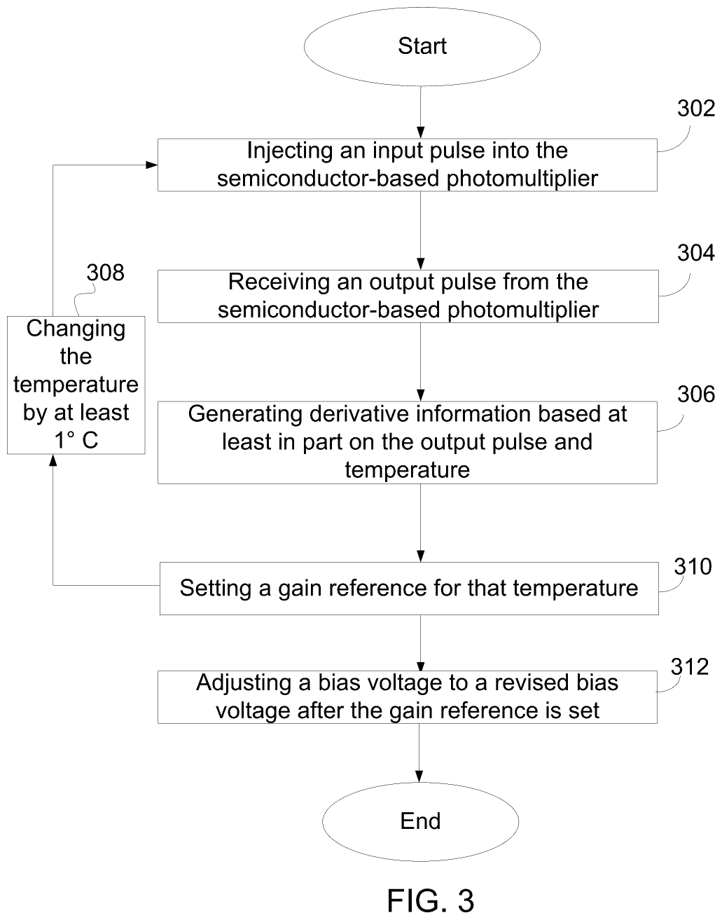

The gain stabilization function is described during operation with respect to the flow chart as illustrated in FIG. 3 and portions of the apparatus 100 as illustrated in FIG. 1 and FIG. 2. The SiPM gain, the amount of charge created for each detected photon, fluctuates over temperature; as temperature increases gain decreases. The light output signal also decreases as temperatures increase. To eliminate the deterioration, gain stabilization is needed. The method determines the breakdown voltage of a light source or crystal that is optically coupled to the semiconductor-based photosensor over a range of measured temperatures. At block 302, an input pulse is injected into the semiconductor-based photomultiplier 152 at room temperature. Referring to FIG. 1, the semiconductor-based photomultiplier 152 can be a SiPM. The processor 222 can send a signal to the pulse injector circuit 130, so that the pulse injector circuit 130 sends a pulse to the semiconductor-based photomultiplier 152. Injecting the pulse can be performed prior to the apparatus leaving the manufacturing site. In a particular embodiment, every fraction of a second, the magnitude of the pulse can be increased in steps (added to the bias voltage) until the input voltage to the semiconductor-based photomultiplier 152 is pushed above the breakdown threshold at the current operating temperature. The fraction of a second can be in a range of 2 ms to 500 ms, or in a range of 5 ms to 50 ms, and the stepped increase in voltage can be in a range of 2 mV to 500 mV, or in a range of 5 mV to 50 mV. When the semiconductor-based photomultiplier 152 is a SiPM, the breakdown threshold can be the average breakdown threshold, as the SiPM has many diodes that do not have the same breakdown voltage.

The method can include receiving an output pulse from the semiconductor-based photomultiplier, at block 304. The input pulse received by semiconductor-based photomultiplier 152 can result in the semiconductor-based photomultiplier 152 generating an output pulse in the form of an electronic pulse that is transmitted by the semiconductor-based photomultiplier 152 and received by the control module 170. The electronic pulse is amplified by the amplifier 202, converted to a digital signal by the ADC 204, and received by the processor 222.

The method can further include generating derivative information based at least in part on the output pulse from the semiconductor-based multiplier 152, at block 306. The processor 222 can analyze the digital signal and generate derivative information. Such derivative information can include whether a neutron or gamma radiation was absorbed by the light source 120, isotope identification, rise time, decay time, emission spectrum, pulse height resolution, or the like. In one embodiment, the output pulse could be a light output of the luminescent material. When the apparatus is an imaging or ranging tool, derivative information can include how far a radiation source, or an object is from the semiconductor-based photomultiplier 152. With respect to gain stabilization, the processor 222 can analyze the corresponding signal from the semiconductor-based photomultiplier 152 and the V_{BR} or breakdown voltage.

Referring to the flow chart in FIG. 3, the branch with setting the gain reference, at 310, is performed after determining the breakdown voltage at each desired measured temperature. Thus, after a first gain reference is determined for a first temperature, the temperature is changed by at least 1° C., at 308, and the method begins again at steps 302, 304, 306, and 308, until the breakdown voltage is determined for each temperature over a full range of temperatures between −20° C. to 55° C. The temperature sensor can provide temperature information that is used for the light output of a luminescent material, such as a scintillator. A temperature sensor may be located within 9 cm, 5 cm, or 0.9 cm of the light source 120. An electronic pulse can be generated by the semiconductor-based photomultiplier 152, and a corresponding digital signal corresponding to the electronic pulse can be adjusted to account for the temperature of the luminescent material. Injected pulses, generating derivative information (e.g., integrated charge), determining the revised bias voltage, and adjusting the bias voltage can be performed with respect to individual temperatures measured over a range of between −20° C. to 55° C. In one embodiment, the measured breakdown voltage at each degree of temperature can be used as a fine adjustment to the bias voltage for each individual apparatus, at a temperature range of about 70 degrees. Thus, the derivative information may be used to set the gain reference based on the charge of the electronic pulse from the semiconductor-based photomultiplier 152 integrated over various temperature ranges. In a particular embedment, the V_{BR} of the semiconductor-based photomultiplier 152 is set over a range of 70 degrees varying 1 degree Celsius at a time. A conversion factor for each degree can be obtained by plotting data of breakdown voltages as a function of temperature corresponding to previously collected output pulses. Thus, the conversion factor can be based on individualized data for that particular apparatus.

Other light sources that are sensitive to temperature can also be used and have similar adjustments. At a particular breakdown voltage, the temperature can be measured. The measured temperature information can be used in determining a compensation factor for light output from the light source. The information can then be stored in the FPGA 224 or memory 226. The stored information thus correlates temperature and gain reference or breakdown voltage for each degree change in temperature.

Once the gain reference is set for each degree Celsius, the method can include adjusting a bias voltage to a revised bias voltage, at block 312. The revised biased voltage can be a constant voltage output of between +/−1% and +/−15% of a breakdown voltage for any given temperature within the temperature range. In one embodiment, the constant voltage output can be between +/−1% and +/−10% of a breakdown voltage for any given temperature within the temperature range. In another embodiment, the constant voltage output can be between +/−1% and +/−5% of a breakdown voltage for any given temperature within the temperature range. In yet another embodiment, the constant voltage output can be between +/−1% and +/−2% of a breakdown voltage for any given temperature within the temperature range. In another embodiment, the constant voltage output can be at most 15%, such as at most 9%, or at most 5%, or at most 3% or at most 1% of a breakdown voltage for any given temperature within the temperature range. In another embodiment, the constant voltage output can be at least 0.002%, such as at least 0.02%, or at least 0.2% of a breakdown voltage for any given temperature within the temperature range.

The processor 222 can send a signal to the bias voltage circuit 124, and the bias voltage circuit 124 can adjust the bias voltage to the revised bias voltage, based on the individualized generated table. The revised bias voltage allows the semiconductor-based photomultiplier 152 to operate closer to the gain for the semiconductor-based photomultiplier 152 as it was set in block 310. Adjusting the bias voltage does not need to be performed every time an input pulse from the pulse injector circuit 130 is injected into the semiconductor-based photomultiplier 152. For example, a threshold value may be used for determining whether or not to adjust the bias voltage. In a particular embodiment, V_{BR} may be less than 0.1% different from a single directly measured breakdown voltage, V_{B2}, and the bias voltage may not be adjusted. After adjusting the bias voltage, a decision can be made whether to continue. If “YES,” the method continues with block 302. Otherwise, the method can end.

Data obtained from a radiation detector contain information about the energies of the impinging particles, and from that it is often possible to determine the radioactive isotope that is emitting the radiation using a process that can be called isotope identification. For this to work reliably, the gain of the SiPM 152 needs to be kept constant, which in turn requires a very stable and constant operating voltage applied across a circuit”. In many practical applications, including when used for isotope identification, the gain needs to be kept constant below +/−5% (or from +/−5% to +/−0.5%) under all operating conditions. The numerical gain of a SiPM is defined as the charge (Q) delivered after absorbing one photon divided by the electron charge e=1.6016e⁻¹⁹C.

$$gain = Q / e$$

The numerical gain is a near-linear function of the applied operating voltage V. Let V_{BR} be the breakdown voltage of the SiPM. The gain as a function of voltage is then:

$$gain = gk * ( V - {V}_{BR} ) for V > {V}_{BR}$$

$$gain = 0 for V < {V}_{B R}$$

The coefficient gain constant, gk, is typically about 1^{e6}/V, but can conceivably range from 0.1^{e6}/V to 10^{e6}/V depending on the particular SiPM design. Under unchanging operating conditions (i.e., in steady state), a practical radiation detector needs to have the same gain when measuring low intensity background radiation as well as when operating in an intense radiation field.

For example, for a 5.08 cm diameter×5.08 cm long cylindrical (2 inch×2 inch) NaI(Tl) scintillator crystal, there should be only a limited gain change when the radiation field intensity increases from near zero (i.e., <10 micro-rem/hour) to 5 mR/hr. For example, for a detector operating at V-V_{BR}=3V a gain shift of 1% is equivalent to a change in operating voltage of 30 mV. To achieve this kind of stability, the electronics can use a power supply with a DC-output impedance of 10 Ohm or less. Even for a worst-case steady state high-load current of 1 mA, the voltage drop would only be 10 mV. Since the breakdown voltage is typically 25V to 35V, the voltage supply needs to have extraordinary stability. Analog boost controllers typically are not designed to deliver that level of accuracy. Operation of the boost controller can be augmented with a C-program running in an ARM micro-controller. It frequently measures the operating voltage with a high-resolution ADC (typically 16-bit) and applies a correction to the nominal operating voltage to achieve a very stable output voltage. This creates a secondary feedback loop, comparing the actual operating voltage to the desired one.

A detector that keeps a constant gain for steady state operation at different radiation intensities that performs satisfactorily in dynamic situations, where the radiation intensity changes suddenly, is hard to achieve. A practical detector must respond quickly and maintain a stable operating voltage in the face of a sudden load change. Hence, the individualized table generated for each combination of crystal and photomultiplier during manufacturing, using the method above, advantageously provides a means to maintaining a gain stabilization within 1 degree of the breakdown voltage at any given temperature.

During or after the method, other actions may occur. For example, a user can implement a more exotic control scheme. Alternatively, a user can manually adjust the bias voltage, set the gain reference, or perform another action. Further, data can be collected and stored in the memory 226, such as timestamp, integrated charge, bias voltage, or the like. The data can be reviewed to monitor or determine the health of the apparatus 100. The apparatus 100 can be configured to analyze a set of bias voltages to monitor or determine the health of the apparatus 100. For example, the changes in bias voltages as a function of time may be increasing. This may be a sign that the semiconductor-based photomultiplier 152 may be getting closer to failing or the apparatus 100 should be shut down soon for maintenance. For example, prior bias voltage may have been within a range of 1%, and a recent or set of bias voltages may be at least 2% greater than the prior adjustments. As another example, prior adjustments to the bias voltage may have had a standard deviation of 0.7%, and a recent or set of recent adjustments to the bias voltage may have a standard deviation of 1.1%. Statistically significant changes to the adjustments, the corresponding standard deviations, or both changes and standard deviations can be used. Thus, a proactive approach to maintaining the apparatus 100 can be used, rather than waiting for the failure to occur, which may happen at an inopportune time.

An advantage of the method is that it can help to stabilize the gain in real time during the normal operation of the apparatus. Since each apparatus has its own individualized look-up table based on data from actual breakdown voltages at various temperatures, the gain stabilization can generate a constant output within +/−1% overvoltage over the breakdown voltage for each apparatus using the method as previously described.

In other words, the method can be performed to calibrate each individual light source while in use with the actual semiconductor-based photomultiplier 152 that is placed in each individual apparatus during manufacturing.

Apparatuses and methods as described herein can be used to help stabilize the gain of a semiconductor-based photomultiplier. As the gain is stabilized, electronic pulses from the semiconductor-based photomultiplier or corresponding digital signals are adjusted in combination with measured temperature changes to determine and set an individual look-up table for a specific crystal already in operation with the semiconductor-based photomultiplier of the apparatus. A calibration light source, a temperature sensor, and temperature information can be used to determine the performance of each individual light source or crystal installed in each apparatus. Further, once the individual stabilization gain table is generated, the method used for continual stabilization can be performed as a background function (not visible to the user) while the apparatus is being used for one or more of its principal functions, such as radiation detection, imaging, ranging, or the like.

FIG. 4 is a representative cross-sectional view of a radiation detection apparatus 400, according to some embodiments. The radiation detection apparatus 400 can be similar to the apparatus 100 of FIG. 1. The radiation detection apparatus 400 includes a housing 110 that contains components therein. The housing may be removably sealed or hermetically sealed. In a particular embodiment, the housing 110 can be sealed in accordance with IP Code rating of IP67, wherein the IP Code is International Electrotechnical Commission standard 60529, Edition 2.2 (2013). Alternatively, or in addition to, components within the housing 110 can be individually hermetically sealed prior to installation in the housing.

The housing 110 contains a scintillator 102 that can include a material that emits scintillating light in response to absorbing radiation, such as gamma rays, ionized particles, or the like. An exemplary non-limiting material for the scintillator 102 includes an alkali halide, a rare earth halide, an elpasolite, a rare-earth containing silicate, perovskite oxide, or the like. For example, the scintillator 102 can comprise any one of a NaI(Tl) crystal, a CsI(Tl) crystal, a CsI(Na) crystal, a LaBr₃ crystal, a CLLB crystal, a LYSO crystal, an LSO crystal, a CdWO₄ crystal, a CeBr₃ crystal, a Strontium Iodide crystal, a BGO crystal, a CaF₂(Eu) crystal, etc. The NaI(TI) crystal is a sodium iodide scintillation crystal activated with thallium. The CsI(TI) crystal is a cesium iodide scintillation crystal activated with thallium. The CsI(Na) crystal is a cesium iodide scintillation crystal activated with sodium. The LaBr₃ crystal is a Lanthanum Bromide crystal. The (Cs₂LiLaBr₆(Ce)) crystal is a gamma-neutron scintillation crystal. The LYSO crystal (Lu_{1.8}Y·₂SiO₅:Ce) is a Cerium doped Lutetium based scintillation crystal. The LSO crystal (Lu₂SiO₅(Ce)) is a Cerium doped Lutetium Oxyorthosilicate based scintillation crystal. The CdWO₄ crystal is a Cadmium tungstate (CdWO₄) scintillation crystal. The CeBr₃ crystal is a cerium bromide (CeBr₃) scintillation crystal. The BGO crystal (Bi₄Ge₃O₁₂) is a Bismuth Germanate based scintillation crystal. The CaF₂(Eu) crystal is a Europium doped Calcium Fluoride based scintillation crystal. Any of these scintillation crystals can be used in the articles and radiation detectors described in this disclosure. A scintillator 102 can be positioned below an optical interface 140 in the housing 110 and optically coupled to the optical interface 140, and impinging radiation 112 can pass through the housing 110 to interact with the scintillator 102. The scintillator 102 can react to the impinging radiation 112 by producing photons 114 that can travel through the optical interface 140 and be detected by the photosensor 150. The photosensor 150 can detect the photons and transfer the data to an external signal processing unit via a connector 190.

When the housing 110 is sealed, materials that are hygroscopic or adversely interact with ambient conditions adjacent to the housing 110 can be protected. The scintillator 102 is surrounded by a reflector 132. The reflector 132 can laterally surround the scintillator 102 or may surround the scintillator on all sides. The reflector 132 can include a specular reflector, a diffuse reflector, or both. In one embodiment, the reflector 132 can be a material selected from the group consisting of fluoropolymer of tetrafluoroethylene, teflon-like material, meilex, and mylar tape.

One or more resilient members can help to keep the scintillator 102 in place within the housing 110. In the embodiment as illustrated, an elastomeric material 134 can surround the reflector 132, and a spring 136 may be disposed between the scintillator 102 and the housing 110. Although not illustrated, a plate may be used between the spring 136 and the scintillator 102 to distribute more uniformly pressure along the surface of the scintillator 102.

One or more semiconductor-based photomultipliers (SiPMs) 152 of the photosensor 150 can be optically coupled to the scintillator 102 via an optical interface 140. In one embodiment, the photosensor 150 can be a semiconductor-based photomultiplier which can include a SiPM or an avalanche photodiode. In one embodiment, the semiconductor-based photomultiplier can include one or more SiPMs 152. The optical interface 140 and the scintillator 102 can be assembled as a hermetically sealed assembly prior to assembly in the housing 110. The optical interface 140 and the scintillator 102 can be optically coupled together using an optical coupling material, such as epoxy, grease, silicon, etc. In the embodiment as illustrated, SiPMs 152 are mounted on a PCB 154. In one embodiment, the SiPMs 152 can be between the PCB 154 and the optical coupler 140. In one embodiment, the optical coupler 140 can be silica. In another embodiment, the SiPMs 152 can be coupled to the optical coupler 140 using an epoxy or rubber silicone.

An electronic pulse from the SiPMs 152 can be routed through the PCB 154 and conductors 162 to an interface board 172. The conductors 162 can be wires (as illustrated), solder balls, optical fiber, or other means that can communicatively couple the PCB 154 to the interface board 172. The impinging radiation 112 can pass through the housing 110, the spring 136, and the reflector 132 to interact with the scintillator 102, which can emit scintillating light as photons 114. With the scintillator 102 surrounded by the reflector 132, the photons should be directed to the optical interface 140 and the SiPMs 152. The reflective layer 156 surrounding the SiPMs 152 can reflect the photons 115 back into the scintillator 102 to later be detected and absorbed by the SiPMs 152.

Microcells within the SiPMs can detect the photons 114 (including reflected photons 115) and produce a current signal which is output to the PCB 154. The current signals from the plurality of microcells can be analyzed to determine the number of photons that have been detected, the detection rate (i.e., detections per second), and other characteristics of the photons 114, and thus characteristics of the impinging radiation 112. The interface board 172 can include electronic components 174, 176, and 178 for processing and other control of the apparatus 100. The interface board 172 can couple the connector 190 to a photosensor 150 for transferring photosensor 150 signals to the connector 190. The photosensor 150 can include a PCB assembly 154, one or more SiPMs 152, and a reflector 156, with the photosensor 150 being optically coupled to an optical interface 140 (e.g., glass). A scintillator 102 can be positioned below the optical interface 140 in the housing and optically coupled to the optical interface 140, and impinging radiation 112 can pass through the housing 110 to interact with the scintillator 102. The scintillator 102 can react to the impinging radiation 112 by producing photons 114 that can travel through the optical interface 140 and be detected by the photosensor 150. The photosensor 150 can detect the photons and transfer the data to an external signal processing unit via the connector 190.

Sensor data, as well as command and control information can be transmitted between the apparatus 100 and a signal processing control system via the connector 190 and the conductors 192. These conductors 192 (as well as conductors 162) can be any medium that transmits energy between a source and a destination, such as electrical conductors, optical conductors, etc. It should also be understood that the conductors may not be in use when the apparatus 100 communicates to the signal processing control system via a wireless transmission.

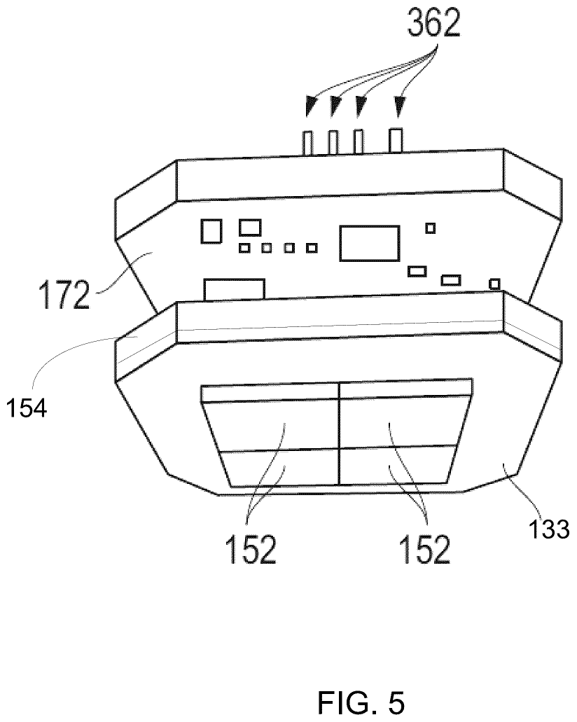

FIG. 5 illustrates the printed wiring board 154 and interface board 172 separated from each other. Four SiPMs are illustrated, although in another embodiment, more or fewer SiPMs may be used. In one embodiment, the printed wiring board 154 can include a first surface 133 that faces the scintillator 102. In one embodiment, the SiPMs 152 can be on the first surface 133 of the printed wiring board 154. Electronic components on the interface board 172 are illustrated but not individually labeled with reference numbers. The interface board 172 can include connectors 362 to transfer data. The radiation detection apparatus 100 can include modular components such as the SIPMs 152 on the carrier board 154, the interface board 172, and the lid. The electronic components on the interface board 172 can be configured to act as a control module 170 as illustrated in FIG. 2.

### Various Embodiments

Embodiment 1. An apparatus comprising a semiconductor-based photomultiplier, the apparatus being configured to maintain a constant centroid shift at zero over a temperature range of 75° C.

Embodiment 2. An apparatus comprising a semiconductor-based photomultiplier, the apparatus being configured to maintain a constant channel per energy output over temperature range of 75° C.

Embodiment 3. An apparatus comprising a semiconductor-based photomultiplier, the apparatus being configured to maintain a characteristic peak of interest (POI) as measured by channel analyzer over a temperature range of 75° C.

Embodiment 4. An apparatus comprising a semiconductor-based photomultiplier, the apparatus being configured to maintain a bias voltage so that the energy output is less than +/−5% of a breakdown voltage.

Embodiment 5. The apparatus of embodiment 1, wherein maintaining the constant voltage is performed at any temperature range between −20° C. and +55° C.

Embodiment 6. The apparatus of embodiment 1, wherein the apparatus further comprises a scintillation crystal.

Embodiment 7. The apparatus of embodiment 1, wherein the apparatus further comprises a pulse injector circuit configured to inject a first input pulse into the semiconductor-based photomultiplier during initial operation of the apparatus.

Embodiment 8. The apparatus of embodiment 6, wherein the apparatus further comprises a memory containing an individualized look-up table of gain stabilization for the specific scintillation crystal provided.

Embodiment 9. A method for stabilizing a radiation detection device, comprising:
determining a breakdown voltage of a light source, wherein the light source is optically coupled to a silicon photomultiplier;
measuring a plurality of light outputs of the light source provided over a temperature range of 75 degrees; and
generating an individualized look-up table for the light source based on the measured plurality of light outputs over the said temperature range.

Embodiment 10. The method of embodiment 9, further comprising maintaining a constant voltage output of between +/−0.002% and +/−3% of the determined breakdown voltage of the light source.

Embodiment 11. The method of embodiment 9, further comprising injecting an input pulse into the silicon photomultiplier.

Embodiment 12. The method of embodiment 11, further comprising receiving an output pulse from the silicon photomultiplier.

Embodiment 13. The method of embodiment 12, further comprising generating a gain value based at least in part on the output pulse of the light source provided over a temperature range of 70 degrees.

Embodiment 14. The method of embodiment 13, wherein the temperature range is between −20° C. and +55° C.

Embodiment 15. The method of embodiment 13, further comprising generating a look-up table with the gain value for each degree over the temperature range.

Embodiment 16. The method of embodiment 15, further comprising maintaining a constant voltage output of +/−1% of the determined breakdown voltage of the light source based on the generated look-up table.

Embodiment 17. The method of embodiment 9, wherein the light source is a luminescent material optically coupled to the semiconductor-based photomultiplier.

Embodiment 18. The method of embodiment 17, wherein the apparatus further comprises a temperature sensor adjacent to an interface between the luminescent material and the semiconductor-based photomultiplier.

Embodiment 19. A method for stabilizing a radiation detection device, comprising: injecting a first input pulse into the semiconductor-based photomultiplier;
determining a breakdown voltage of a luminescent material, wherein the luminescent material is optically coupled to a silicon photomultiplier provided;
measuring a plurality of light outputs of the scintillator provided over a temperature range of 75 degrees; and
generating an individualized look-up table for the scintillator based on the measured plurality of light outputs over the said temperature range.

Embodiment 20. The method of embodiment 19, further comprising receiving an output pulse from the silicon photomultiplier.

Embodiment 21. The method of embodiment 20, further comprising generating a gain value based at least in part on the output pulse of the light source provided over a temperature range of 70 degrees.

Embodiment 22. The method of embodiment 21, wherein the temperature range is between −20° C. and +55° C.

Embodiment 23. The method of embodiment 21, wherein the look-up table comprises a gain value for each degree within the temperature range.

The foregoing embodiments represent a departure from the state-of-the-art. Notably, the embodiments herein include a combination of features not previously recognized in the art and facilitate performance improvements.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description of the Drawings, with each claim standing on its own as defining separately claimed subject matter.

What is claimed is:

1. An apparatus comprising a semiconductor-based photomultiplier, the apparatus maintaining a constant centroid shift at zero over a temperature range of 75° C.

2. The apparatus of claim 1, wherein the apparatus maintains a constant channel per energy output over temperature range of 75° C.

3. The apparatus of claim 1, wherein the apparatus maintains a characteristic peak of interest (POI) as measured by channel analyzer over a temperature range of 75° C.

4. The apparatus of claim 1, wherein the apparatus maintains a bias voltage so that the energy output is less than +/−5% of a breakdown voltage.

5. The apparatus of claim 1, wherein maintaining the constant voltage is performed at any temperature range between −20° C. and +55° C.

6. The apparatus of claim 1, wherein the apparatus further comprises a scintillation crystal.

7. The apparatus of claim 1, wherein the apparatus further comprises a pulse injector circuit configured to inject a first input pulse into the semiconductor-based photomultiplier during initial operation of the apparatus.

8. The apparatus of claim 6, wherein the apparatus further comprises a memory containing an individualized look-up table of gain stabilization for the specific scintillation crystal provided.

9. A method for stabilizing a radiation detection device, comprising:
determining a breakdown voltage of a light source, wherein the light source is optically coupled to a silicon photomultiplier;
measuring a plurality of light outputs of the light source provided over a temperature range of 75 degrees; and
generating an individualized look-up table for the light source based on the measured plurality of light outputs over the said temperature range.

10. The method of claim 9, further comprising maintaining a constant voltage output of between +/−0.002% and +/−3% of the determined breakdown voltage of the light source.

11. The method of claim 9, further comprising injecting an input pulse into the silicon photomultiplier.

12. The method of claim 11, further comprising receiving an output pulse from the silicon photomultiplier.

13. The method of claim 12, further comprising generating a gain value based at least in part on the output pulse of the light source provided over a temperature range of 70 degrees.

14. The method of claim 13, wherein the temperature range is between −20° C. and +55° C.

15. The method of claim 13, further comprising generating a look-up table with the gain value for each degree over the temperature range.

16. The method of claim 15, further comprising maintaining a constant voltage output of +/−1% of the determined breakdown voltage of the light source based on the generated look-up table.

17. The method of claim 9, wherein the light source is a luminescent material optically coupled to the semiconductor-based photomultiplier.

18. The method of claim 17, wherein the apparatus further comprises a temperature sensor adjacent to an interface between the luminescent material and the semiconductor-based photomultiplier.

19. A method for stabilizing a radiation detection device, comprising:
injecting a first input pulse into the semiconductor-based photomultiplier;
determining a breakdown voltage of a luminescent material, wherein the luminescent material is optically coupled to a silicon photomultiplier provided;
measuring a plurality of light outputs of the scintillator provided over a temperature range of 75 degrees; and
generating an individualized look-up table for the scintillator based on the measured plurality of light outputs over the said temperature range.

20. The method of claim 19, further comprising receiving an output pulse from the silicon photomultiplier over the temperature range of between −20° C. and +55° C.
